(19) United States
(12) Patent Application Publication
(10) Pub. No.: US 2015/0309186 A1
(43) Pub. Date: Oct. 29, 2015

(54) System, Method And Apparatus For Personal Radiation Dosimeter

(71) Applicant: Saint-Gobain Ceramics & Plastics, Inc., Worcester, MA (US)

(72) Inventor: John M. FRANK, Hartville, OH (US)

(21) Appl. No.: 14/241,967

(22) PCT Filed: Sep. 5, 2012
(86) PCT No.: PCT/US12/53789

§ 371 Date: Jun. 16, 2014

Related U.S. Application Data
(60) Provisional application No. 61/531,743, filed on Sep. 7, 2011.

(51) Int. Cl. G01T 1/105

(52) U.S. Cl. CPC G01T 1/105

(57) ABSTRACT

A personal radiation dosimeter may comprise a housing that is substantially light-impermeable. The housing contains a radiation energy sensitive component (RESC) that is transported by a user. A reader has ingress and egress for the housing, and an internal stimulation light to photo-stimulate the RESC. An internal photosensor senses photons from the RESC after photo-stimulation and generates a signal. The photosensor may convert and amplify the RESC signal into a signal corresponding to the amount of radiation. A processing circuit may be used to assess an amount of radiation incident on the RESC based on the signal. In addition, the reader may contain a reset light to reset the RESC for reuse after the amount of radiation is detected.

### BACKGROUND OF THE INVENTION

1. Field of the Disclosure

The present invention relates in general to radiation detection and, in particular, to a system, method and apparatus for a personal radiation dosimeter.

2. Description of the Related Art

Ionizing radiation sources such as x-rays are sometimes used on individuals for security or medical-related applications. Although radiation systems are calibrated to limit exposure and danger to humans, there is no ongoing knowledge of the dosages people are subjected to. Despite these precautions, some travelers and medical patients are wary of radiation dosages and desire to have a personal means of monitoring their exposure. Unfortunately, individuals have no simple way to know what radiation dose is absorbed by their body when they are subjected to such procedures.

There have been a number of approaches to address this problem. However, some radiation systems such as backscatter security scanners make it difficult to carry a sensor and not affect the test. Other issues include the cost of such sensors and the significant time required to obtain the radiation exposure results. For example, the Transportation Security Administration (TSA) is having difficulty providing exposure results to travelers after they have whole body backscatter x-ray scans. Similarly, hospitals do not provide individual exposure data to patients due to cost and complexity. There is no low cost, simple to use, mass producible means to know radiation exposure levels from backscatter devices, or even to baggage scanners that may be leaking ionizing radiation. Thus, improved solutions continue to be of interest.

### SUMMARY

Embodiments of a system, method and apparatus for a personal radiation dosimeter are disclosed. The personal radiation dosimeter may comprise a housing that is substantially light-impermeable. The housing contains a radiation energy sensitive component (RESC), such as a storage phosphor plate (SPP), that is transported by a user. A reader has ingress and egress for the housing, and an internal stimulation light to photo-stimulate the RESC. An internal mechanism reads the RESC (e.g., a photosensor may sense photons from the SPP) after photo-stimulation and generates a signal. The photosensor may convert and amplify the RESC signal into a signal corresponding to the amount of radiation. A processing circuit may be used to assess an amount of radiation incident on the RESC based on the signal. In addition, the reader may contain a reset light to reset the RESC for reuse after the amount of radiation is detected.

Other embodiments comprise a method of radiation detection such as affixing a radiation detector to a user; exposing a radiation detector to a dosage of radiation and storing a portion of the energy deposited in the radiation detector; putting the radiation detector in a reader; stimulating the radiation detector to release photons in proportion to the radiation dosage; calculating a photon charge in response to the radiation dosage; displaying the radiation dosage; erasing the radiation detector with the reader; removing the radiation detector from the reader; and reusing the radiation detector for detecting another dosage of radiation.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIGS. 1 and 2 are schematic isometric and top views of an embodiment of a radiation detector;

FIGS. 3 and 4 are schematic isometric and diagram views of an embodiment of a reader for a radiation detector; and

FIG. 5 is high level flow diagram of an embodiment of a method of radiation detection.

The use of the same reference symbols in different drawings indicates similar or identical items.

### DETAILED DESCRIPTION

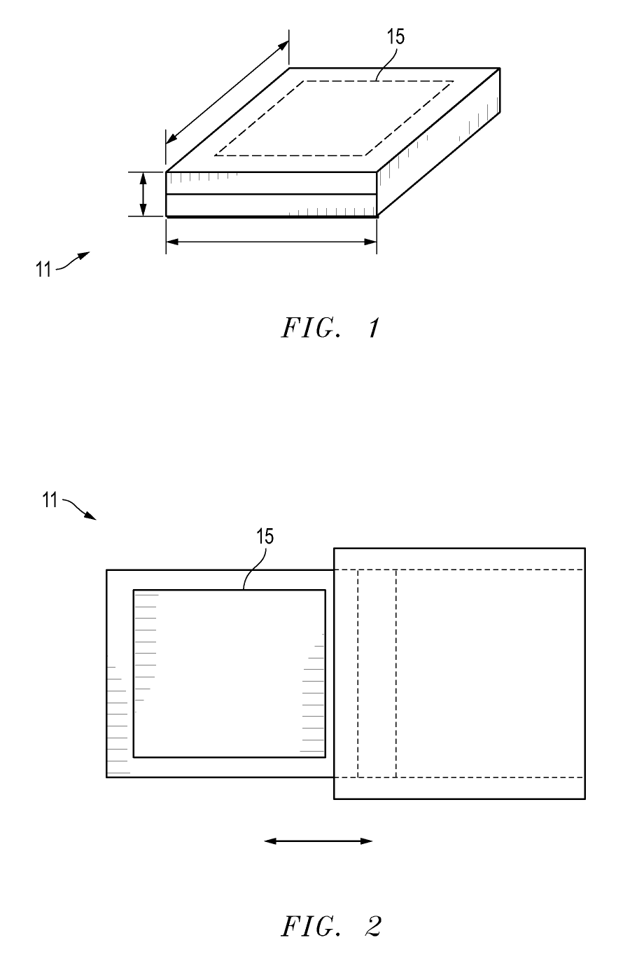

Embodiments of a system, method and apparatus for a personal radiation dosimeter are disclosed. As shown in FIGS. 1-4, a personal radiation dosimeter 11 may comprise a carrier or housing 13 that is substantially light-impermeable. The housing 13 contains a radiation energy sensitive component (RESC) 15, such as a storage phosphor plate (SPP). The housing 13 is configured to be transported by a user. The housing 13 may be square in shape and comprise a size in a range of about 1 cm² to about 3 cm².

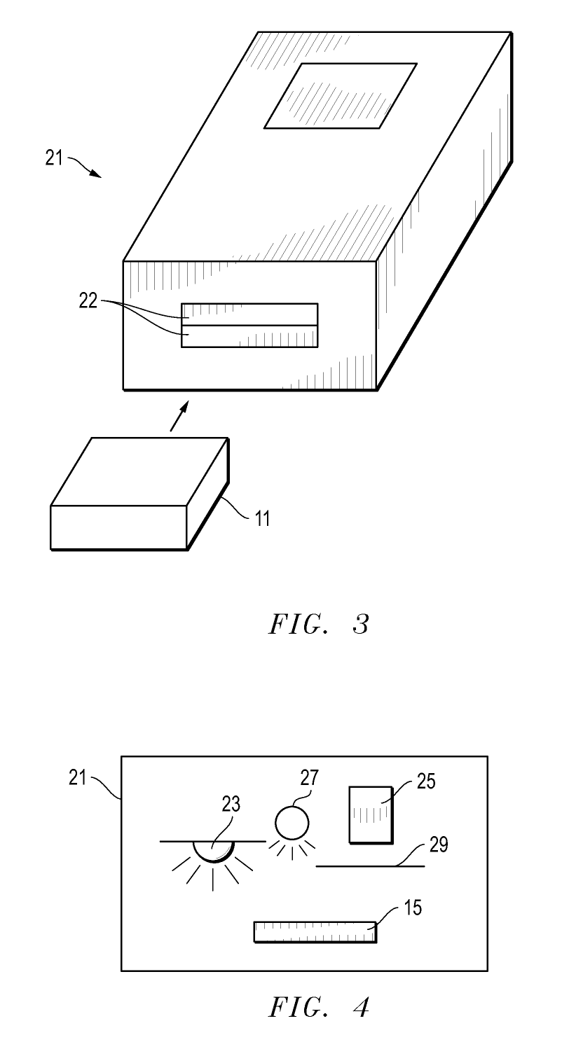

A reader 21 having ingress and egress for the housing 13 also is provided. As shown in FIG. 3, the reader 21 may be provided with doors 22 that maintain an interior of the reader 21 in a light-impermeable condition when the doors 22 are closed. The reader 21 has an internal stimulation light 23 (FIG. 4) that is configured to photo-stimulate the RESC 15. An internal photosensor 25 is configured to sense photons from the RESC 15 resulting from photo-stimulation and generate a signal. The photosensor 25 may be configured to convert and amplify the RESC signal into a signal corresponding to the amount of radiation.

A processing circuit is configured to assess an amount of radiation (e.g., x-rays or gamma rays) incident on the RESC 15 based on the signal. In addition, the reader 21 contains a reset light 27 configured to reset the RESC 15 for reuse after the amount of radiation is determined. Thus, the reader 21 is configured to open the housing 13 to allow photo-stimulation, to read and to reset the RESC 15, and close the housing 13 to again make it substantially light impermeable.

Embodiments of the reader 21 also may be configured to record the amount of radiation, maintain a running total of radiation exposure from a plurality of uses of the RESC 15, and to record a maximum single exposure of the RESC 15 to radiation over a period of time. In some embodiments, the RESC 15 is immediately readable by the reader, and up to within about 1 to 4 hours after the RESC 15 is exposed to a radiation dose.

In some embodiments, the photosensor 25 may be a photodiode, and the stimulation light 27 may comprise a light emitting diode (LED) or LED laser. For example, the photosensor 25 may comprise at least one of a photodiode, an avalanche photodiode (APD) and a silicon photomultiplier (SiPM) that is configured to operate in a range of about 350 nm to about 450 nm. The LED 27 may comprise about a 630 nm to about a 650 nm wavelength-emitting LED. The reader 21 may further comprise a wavelength filter 29 (e.g., approximately 500 nm) between the photosensor 25 and the stimulation light 23. The reset light 27 may be configured to emit substantially white light with sufficient intensity to reset the RESC 15.

In other embodiments, the personal radiation dosimeter further comprises a plurality of housings 13, each with unique identifiers assigned to respective individual users, and the reader 21 is configured to maintain separate records for each unique identifier. For example, the unique identifiers may comprise radio frequency identification (RFID).

Other embodiments of the personal radiation dosimeter comprise a carrier that is substantially light-impermeable and contains a storage phosphor plate (SPP) that detects radiation, and the carrier is configured to be carried by a user; and a reader having ingress and egress for the carrier, a stimulation light configured to photo-stimulate the SPP, a photosensor configured to sense photons from the SPP after photo-stimulation and generate a signal, a processing circuit configured to assess an amount of radiation incident on the SPP based on the signal, and a reset light configured to reset the SPP for reuse after the amount of radiation is detected. In some examples, the SPP may comprise BaFBr:Eu2+, CsBr:Eu2+, BaFBrxI1-x:Eu2+, BaFBr:Ce3+, or RbBr:T1. The photo stimulation may be configured to stimulate the SPP for about 0.5 seconds to about 1.75 seconds to obtain a substantial amount (e.g., at least about 70%) of the signal.

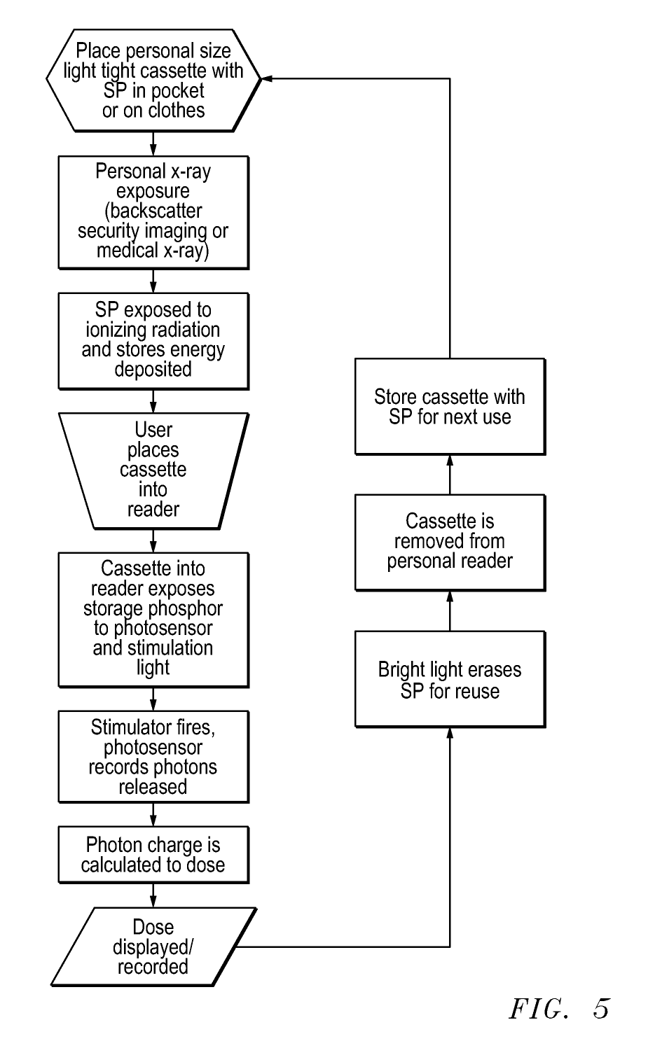

Referring now to FIG. 5, an embodiment of a method of radiation detection may comprise affixing a radiation detector to a user; exposing a radiation detector to a dosage of radiation with an attendant storing of at least a portion of the energy deposited in the radiation detector; putting the radiation detector in a reader; stimulating the radiation detector to release photons in proportion to the radiation dosage; sensing the released photons; determining the radiation dosage in proportion to the released photons; displaying the radiation dosage; erasing the radiation detector with the reader; removing the radiation detector from the reader; and reusing the radiation detector for detecting another dosage of radiation. The method may further comprise repeating these steps for multiple usages of the same radiation detector.

Still other embodiments further comprise recording the radiation dosage, maintaining a running total of radiation exposure from a plurality of uses of the radiation detector, and recording a maximum single exposure of radiation to the radiation detector over a period of time. Some of the steps may occur in a range of immediately after exposure up to within about 4 hours after the radiation detector is exposed to radiation. The method may further comprise maintaining the radiation detector in an open position during some of the intermediate steps, and returning the radiation detector to a closed position before it exits the reader.

Embodiments may further comprise a plurality of radiation detectors, each with unique identifiers assigned to respective individual users, maintaining separate records with the reader for each unique identifier. Some steps may comprise converting and amplifying a signal corresponding to the radiation dosage. Photons stored by the RESC may be sensed with a photodiode, and the RESC may be stimulated by exposure to a light emitting diode (LED) or LED laser in a range of about 630 nm to about 650 nm, for example. The stored signal sensing step may comprise emitted photon detection in a range of about 350 nm to about 450 nm (for a time span of, for example, about 0.5 to 1.75 seconds), and erasing stored information may comprise operating in a range of visible light, using a wavelength filter between these regions.

These embodiments have numerous advantages. For example, personal radiation dosimeters as described herein are readily suitable for use by airport travelers, dental patients, hospital patients and others who desire to know their ionizing radiation exposure to such dosages over short time frames. The components are small, lightweight and easily transported for use. Results may be provided quickly after exposure, and the system is compatible with personal computers and smart phones for data tracking and communications. The dosimetry media can be reused and is compatible with security scanners to permit logging dose while going through imagers without flagging screeners due to small size and lack of metal components. The media does not need to be sent away or read by large equipment. Feedback to the user can occur within minutes after exposure. Embodiments include quantitative results from a unit about the size of a universal serial bus (USB) storage key and which has low power consumption.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the orders in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A personal radiation dosimeter, comprising:
a housing that is substantially light-impermeable and contains a radiation energy sensitive component (RESC), and the housing is configured to be transported by a user; and
a reader having ingress and egress for the housing, a stimulation light configured to photo-stimulate the RESC, a photosensor configured to sense photons resulting from photo-stimulation and generate a signal, a processing circuit configured to assess an amount of radiation incident on the RESC based on the signal, and a reset light configured to reset the RESC for reuse after the amount of radiation is determined.

2. A personal radiation dosimeter according to claim 1, wherein the reader also is further configured to record the amount of radiation, maintain a running total of radiation exposure from a plurality of uses of the RESC, and to record a maximum single exposure of radiation over a period of time.

3. A personal radiation dosimeter according to claim 1, wherein the RESC is immediately readable by the reader and up to within about 4 hours after the RESC is exposed to radiation.

4. A personal radiation dosimeter according to claim 1, wherein the reader is configured to open the housing to allow photo-stimulation, to read and to reset the RESC, and close the housing to again make it substantially light impermeable.

5. A personal radiation dosimeter according to claim 1, further comprising a plurality of housings, each with unique identifiers assigned to respective individual users, and the reader is configured to maintain separate records for each unique identifier.

6. (canceled)

7. A personal radiation dosimeter according to claim 1, wherein the radiation comprises x-rays or gamma rays, and the photosensor is configured to convert and amplify the RESC signal into a signal corresponding to the amount of radiation.

8. (canceled)

9. (canceled)

10. (canceled)

11. A personal radiation dosimeter, comprising:
a carrier that is substantially light-impermeable and contains a storage phosphor plate (SPP) that detects radiation, and the carrier is configured to be carried by a user; and
a reader having ingress and egress for the carrier, a stimulation light configured to photo-stimulate the SPP, a photosensor configured to sense photons from the SPP resulting from photo-stimulation and generate a signal, a processing circuit configured to assess an amount of radiation incident on the SPP based on the signal, and a reset light configured to reset the SPP for reuse after the amount of radiation is determined.

12. A personal radiation dosimeter according to claim 11, wherein the reader also is further configured to record the amount of radiation, maintain a running total of radiation exposure from a plurality of uses of the SPP, and to record a maximum single exposure of radiation over a period of time.

13. A personal radiation dosimeter according to claim 11, wherein the SPP is immediately readable by the reader and up to within about 4 hours after the SPP is exposed to radiation.

14. A personal radiation dosimeter according to claim 11, wherein the reader is configured to open the carrier to allow photo-stimulation, to read and to reset the SPP, and close the carrier to again make it substantially light impermeable.

15. A personal radiation dosimeter according to claim 11, further comprising a plurality of housings, each with unique identifiers assigned to respective individual users, and the reader is configured to maintain separate records for each unique identifier.

16. (canceled)

17. A personal radiation dosimeter according to claim 11, wherein the radiation comprises x-rays or gamma rays, and the photosensor is configured to convert and amplify the SPP signal into a signal corresponding to the amount of radiation.

18. A personal radiation dosimeter according to claim 11, wherein the photosensor is a photodiode, and the stimulation light comprises a light emitting diode (LED) or LED laser.

19. (canceled)

20. A personal radiation dosimeter according to claim 11, wherein the reset light is configured to emit substantially white light with sufficient intensity to reset the SPP.

21. (canceled)

22. (canceled)

23. A method of radiation detection, comprising:
(a) exposing a radiation detector to a dosage of radiation and storing at least a portion of the energy deposited in the radiation detector;
(b) putting the radiation detector in a reader;
(c) stimulating the radiation detector to release photons in proportion to the radiation dosage;
(d) sensing the released photons;
(e) determining the radiation dosage in proportion to the released photons;
(f) displaying the radiation dosage;
(g) erasing the radiation detector with the reader;
(h) removing the radiation detector from the reader; and
(i) reusing the radiation detector for detecting another dosage of radiation.

24. A method according to claim 23, further comprising recording the radiation dosage, maintaining a running total of radiation exposure from a plurality of uses of the radiation detector, and recording a maximum single exposure of radiation to the radiation detector over a period of time.

25. A method according to claim 23, wherein at least steps (b) through (e) occur in a range of immediately after exposure up to within about 4 hours after the radiation detector is exposed to radiation.

26. A method according to claim 23, further comprising maintaining the radiation detector in an open position during steps (c)-(g), and returning the radiation detector to a closed position before step (h).

27. (canceled)

28. (canceled)

29. A method according to claim 23, further comprising operating step (c) in a range of about 350 nm to about 450 nm, operating step (f) in a range of about 630 nm to about 650 nm, using a wavelength filter between steps (c) and (f).

30. A method according to claim 23, wherein step (c) lasts about 0.5 seconds to about 1.75 seconds.
